(19) United States
(12) Patent Application Publication
(10) Pub. No.: US 2002/0160683 A1
(43) Pub. Date: Oct. 31, 2002

(54) Filter material with improved infusion characteristics

(76) Inventors: Horst Dannhauser, Gernsbach (DE); Danny Meger, Gernsbach (DE); Hartmut Salow, Ahrensburg (DE)

Correspondence Address: PENNIE AND EDMONDS, 1155 AVENUE OF THE AMERICAS, NEW YORK, NY, 100362711

(21) Appl. No.: 10/021,778

(22) Filed: Dec. 13, 2001

(30) Foreign Application Priority Data
Dec. 13, 2000 (DE) 100 62 031.0

(51) Int. Cl. B32B 7/12; B32B 21/10

(52) U.S. Cl. 442/414; 442/385; 442/389

(57) ABSTRACT

A filter material is described, in particular for preparing filter pouches and filter bags for infusion beverages which due to its content of superabsorber fibers which absorb large amounts of liquid allows an optimal leaching of the filling material to be infused even without movement in the leaching liquid, as well as a process for preparing such a filter material.

The present invention refers to a filter material or paper with substantially improved infusion characteristics such that a bag fabricated therefrom and filled with material to be infused provides an infusion intense in color and aroma within a shorter time than a bag known in the art.

The preparation of filter materials for hot and cold filtration such as teabags, coffee bags, filter bags for aromas and/or spices and filter papers for tea and coffee for the beverage industry is known in the art.

Generally, the preparation of a filter material is performed from a filter base material, e.g. from natural fibers or a combination of natural fibers and synthetic fibers by using a specific paper machine in a manner known in the respective field of the art per se.

In a first step an aqueous suspension of natural fibers is applied onto a paper machine screen, whereupon the fiber suspension is passed over first dehydration chambers. Hereby a first fiber layer of the natural fibers is formed on the moving screen. If a heat-sealable paper of both natural fibers and synthetic fibers is produced, in a second step during continuation of movement of the paper machine screen, the hot-sealable synthetic fibers in the form of a second suspension are passed over second dehydration chambers, wherein over the second dehydration chambers a second layer of synthetic fibers is deposited on the first layer. When continuing the movement of the paper machine screen having the two fiber layers lying one upon the other drying is performed, whereby the synthetic fibers can be fused onto the first fiber layer such that they bind with the natural fibers of the first layer.

This can result in a partial permeation of the two layers.

The heat-sealable or non heat-sealable filter material prepared according to the above-described method is finally formed into bags and filled with tea in automatic packaging processors.

Conventionally tea having a high amount of fine tea particles is packed. If the tea filter material has, as actually desired, a high porosity, i.e. a higher number of holes, fine tea particles fall through the pores, which is extremely undesireable in using and even transporting the bags. One possibility of preventing this disadvantage is to form considerably smaller pores so that the tea dust loss is reduced. However, at the same time the tea infusion is reduced.

EP 94 107 709.1 describes a tea filter material consisting of a base layer and a so-called meltblown polymer layer. In the known tea filter material the necessary pores are staggered with respect to one another without any significant deterioration of the infusion so that the tea loss is minimized.

According to U.S. Pat. No. 4,289,580 the surface of the filter paper is hydrophilized by a surfactant. Further, on the paper machine the filter material is subjected to a hydrodynamic perforation so as to optimize the tea infusion.

As mentioned, in using a filter material as a bag for tea and other extractable filling materials, rapid leaching (infusion) is desired. In the presently used tea filter papers, however, a high concentration of extracted tea is very rapidly formed without moving the bag at the interface water/filter paper. This high concentration (blocking concentration) inhibits a further leaching of the filling material “tea”, as the concentration gradient between inside the bag and outside the bag is not restored without moving the bag.

The object of the present invention is to provide filter materials or papers particularly for infusion beverages allowing an optimal leaching of the filling material even without movement in the infusion liquid. A further object of the present invention is to provide a process for preparing such filter materials or papers.

The solution of this object is based on the finding that by incorporating a certain amount of strongly water-absorbing fibers, also referred to as “superabsorber fibers”, into the filter base material the resulting filter material in the form of bags does not have to be moved in the infusion liquid to ensure an optimal leaching of the filling material.

As one aspect of the invention, there is provided a filter material particularly for preparing filter pouches and filter bags for infusion beverages, characterized in that it contains superabsorber fibers in an amount of between 1 and 70% by weight relative to the area weight of the filter material.

Another aspect of the invention is a process for preparing a filter material particularly for preparing filter pouches and filter bags for infusion materials characterized in that in the wet section of the paper machine superabsorber fibers in an amount of 1-70% by weight relative to the area weight of the resulting filter material are incorporated into the filter base material used on the paper machine.

By means of the superabsorber fibers incorporated into the filter material according to the invention, the above-described blocking concentration on the surface of the bag is eliminated even without mechanically moving the bag, as when absorbing water the superabsorber fibers are subjected to a strong change of form, are moved and cause a micro-whirling at the interface. By means of this micro-whirling of the superabsorber fibers the necessary concentration gradient at the paper interface is restored. The result is a faster leaching of the tea or the filling material.

The term “high water-absorbent superabsorber fibers”, as used according to the invention, means fibers capable of absorbing large amounts of liquids such as water by swelling, e.g. when free swelling takes place, depending on the electrolyte content of the liquid about 25, 30, 50, 60 or even 85 g liquid per g fiber within a time limit of about 20 min (for comparison conventional cellulose only absorbs about 3 g liquid per g fiber). The superabsorber fibers to be used according to the invention, which for example are already used as materials for cable shieldings or in diapers, are preferably (meth)acrylate copolymers, such as copolymers comprising (meth)acrylate and styrene, acrylate and methacrylate, vinyl acetate and (meth)acrylate, vinylidene chloride and (meth)acrylate, acrylamide and (meth)acrylate, or butadiene and (meth)acrylate. More preferably the copolymers used according to the invention are cross-linked acrylate copolymers, particularly those partly present in a salt form such as sodium salt form. Such copolymers are partially commercially available such as under the trade name of Oasis 101, 111, 112, 121 or 122 from Technical Adsorbents LTD., Grimsby, GB or Fiberan® and Fibergarb® from Camelot Technologies, High River, Alberta, Canada. Modified copolymers of maleic anhydride and isobutylene, e.g. Fiversorb® from Camelot Technologies Ltd. may also be used.

The filter material according to the invention usually has an area weight of between 8 and 90 g/m², preferably of between 10 and 25 g/m². The filter base material combined with the superabsorber fibers can be made from natural fibers and synthetic fibers. The natural fibers may for example be such of conifer cellulose and abaca fibers. If the filter material according to the invention is a two-layer filter material, the first layer or sheet usually comprises from 60 to 90% by weight and the second layer or sheet comprises from 10 to 40% by weight relative to the area weight of the filter material. Usually the first layer consists of natural fibers and the suberabsorber fibers to be added according to the invention. When a heat-sealable filter material is to be prepared, according to the invention a second layer mainly consisting of sealable polymer fibers can be coated onto the first layer. Thus a heat-sealable filter material is obtained.

Upon implementation of the process according to the invention the superabsorber fibers are added, preferably in an amount of from 1 to 70% by weight, more preferably from 2 to 30% by weight, most preferably from 3 to 8% by weight relative to the area weight of the filter material to the filter base material prepared on the paper machine. The fibers can be used as a mixture with the natural fibers in the conventional wet process. The fiber bonding is effected by natural hydrogen bonding as usually. However, it is also possible to integrate the superabsorber fibers into the filter material by latex bonding, mechanical matting (pin matting), by hydrodynamic strengthening (water jets) or by thermal bonding using appropriate synthetic bonding fibers.

The following example will further illustrate the invention.

### EXAMPLE

The improved tea infusion of bags comprising superabsorber fibers compared to teabags, which do not comprise superabsorber fibers, can be detected by extinction measurement.

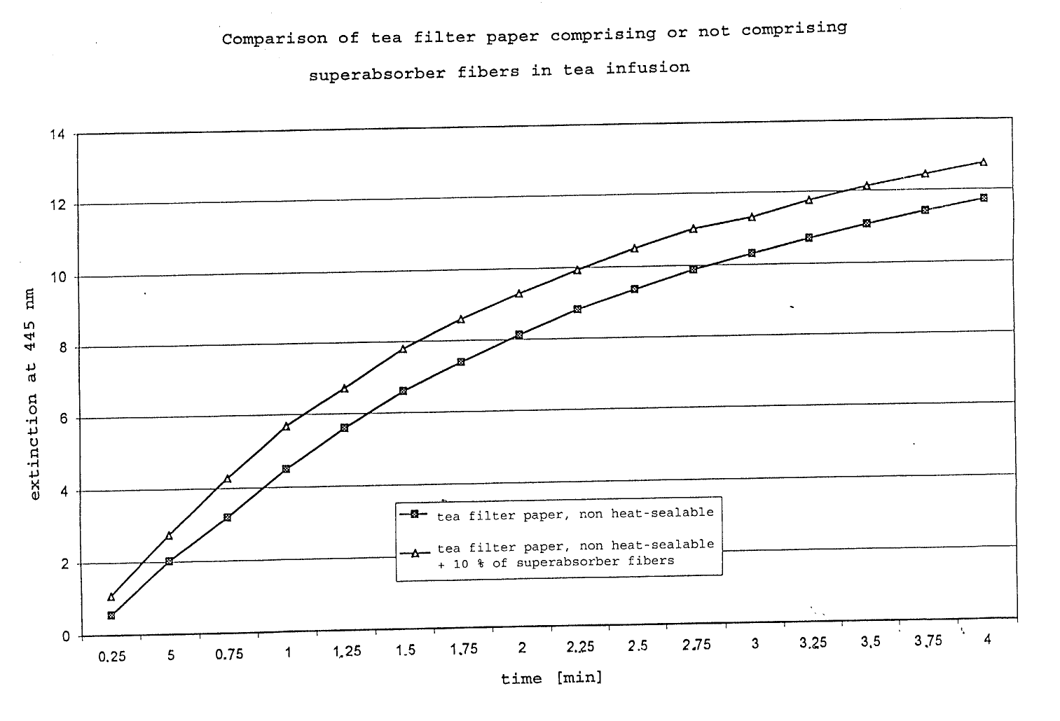

For this measurement teabags of a total area weight of 12.2 g/m² are prepared from a filter base material having conventional dimensions of an area weight of 11 g/m² and optionally about 1.2 g/m² superabsorber fibers Oasis 101, the resulting tea bags are filled with “black tea”. A predetermined amount of boiling water is poured over one teabag. By means of a pumping action the resulting (colored) tea is circulated through a photometer. A light beam having a wavelength of 445 nm passes through the pumped tea liquid through. The measured extinction is digitally recorded. The extinction is a measure of the attenuation of a beam due to absorption in the liquid. The higher the extinction, the darker the tea infusion. The graph appended as FIG. 1 clearly shows that, for example at the usual infusion time of 3 min, the teabag prepared from filter base material and superabsorber fibers exhibits an 8-10% higher extinction and thus a better tea infusion than the conventional bag.

The effect of the improved tea infusion can be improved by an increased addition of superabsorber fibers. An amount ratio of between 2 and 30% by weight, preferably 3 and 10% by weight of superabsorber fibers relative to the area weight of the filter material has proven particularly advantageous.

What is claimed is:

1. A filter material for the preparation of filter pouches and filter bags for infusion beverages, characterized in that said filter material comprises a filter base material and a superabsorber material consisting of fibers, wherein the amount of said superabsorber fibers is from about 1 to about 70% by weight relative to the area weight of the filter material.

2. The filter material according to claim 1, characterized in that the area weight of said filter material is from about 8 to about 90 g/m².

3. The filter material according to claim 1, characterized in that the area weight of said filter material is from about 10 to about 25 g/m².

4. The filter material according to claim 1, characterized in that said the filter base material is formed of natural fibers.

5. The filter material according to claim 4, wherein the natural fibers are selected from conifer cellulose, deciduous wood cellulose and abaca fibers.

6. The filter material according to claim 1, characterized in that said filter material comprises two layers,
a first layer which comprises natural fibers and the superabsorber fibers, and
a second layer which comprises sealable polymer fibers, and wherein said second layer is coated onto said first layer.

7. The filter material according to claim 1, characterized in that said filter material comprises superabsorber fibers in an amount from about 2 to about 30% by weight relative to the area weight of the filter material.

8. The filter material according to claim 6, characterized in that said filter material comprises superabsorber fibers in an amount from about 2 to about 30% by weight relative to the area weight of the filter material.

9. The filter material according to claim 1, characterized in that said filter material comprises superabsorber fibers in an amount from about 3 to about 10% by weight relative to the area weight of the filter material.

10. The filter material according to claim 6, characterized in that said filter material comprises superabsorber fibers in an amount from about 3 to about 10% by weight relative to the area weight of the filter material.

11. A process for preparing a filter material according to claim 1, comprising incorporating superabsorber fibers into the filter base material in the wet section of a paper machine, wherein the amount of said superabsorber fibers in from about 1 to about 70% by weight.

12. A process according to claim 11, characterized in that the superabsorber fibers are bound to the filter base material by latex or other chemical binders.

13. A process according to claim 11, characterized in that the superabsorber fibers are bound to the filter base material by mechanical strengthening.

14. A process according to claim 11, characterized in that the superabsorber fibers are bound to the filter base material by hydrodynamic strengthening.

15. A process according to claim 11, characterized in that the superabsorber fibers comprise a (meth)acrylate copolymer.

16. A process according to claim 15, characterized in that the superabsorber fibers comprise a cross-linked acrylate copolymer, optionally in salt form.

17. A process for preparing a filter material according to claim 6, comprising incorporating superabsorber fibers into the filter base material in the wet section of a paper machine, wherein the amount of said superabsorber fibers in from about 1 to about 70% by weight.

18. A process according to claim 17, characterized in that the superabsorber fibers are bound to the filter base material by latex or other chemical binders.

19. A process according to claim 17, characterized in that the superabsorber fibers are bound to the filter base material by mechanical strengthening.

20. A process according to claim 17, characterized in that the superabsorber fibers are bound to the filter base material by hydrodynamic strengthening.

21. A process according to claim 17, characterized in that the superabsorber fibers comprise a (meth) acrylate copolymer.

22. A process according to claim 21, characterized in that the superabsorber fibers comprise a cross-linked acrylate copolymer, optionally in salt form.
